(19) United States
(12) Patent Application Publication
(10) Pub. No.: US 2025/0284916 A1
(43) Pub. Date: Sep. 11, 2025

(54) DYNAMIC PRINT PARAMETER ADJUSTMENT MECHANISM

(71) Applicants: Walter F. Kailey, Boulder, CO (US); Samuel Hopper, Boulder, CO (US); Ke Huang, Boulder, CO (US)

(72) Inventors: Walter F. Kailey, Boulder, CO (US); Samuel Hopper, Boulder, CO (US); Ke Huang, Boulder, CO (US)

(73) Assignee: Ricoh Company, Ltd., Tokyo (JP)

(21) Appl. No.: 18/596,998

(22) Filed: Mar. 6, 2024

(51) Int. Cl. G06K 15/02

(52) U.S. Cl. CPC G06K 15/1881; G06K 15/027

(57) ABSTRACT

A system is disclosed. The system includes a printing system comprising at least one physical memory device to store compensation logic and one or more processors coupled with the at least one physical memory device to execute the compensation logic to receive sheetside compensation instructions from an external device; wherein the sheetside compensation instructions specify compensation resources, determine a first of a plurality of sheetside images for application of the compensation resources, determine a sheet identifier (ID) corresponding to the first sheetside image, process the first sheetside image by applying the compensation resources to the first sheetside image and transmit the sheet ID to the external device.

### FIELD OF THE INVENTION

The invention relates to the field of image reproduction, and in particular, to printer calibration.

### BACKGROUND

Entities with substantial printing demands typically implement a high-speed production printer for volume printing (e.g., one hundred pages per minute or more). Production printers may include continuous-forms printers that print on a web of print media (or paper) stored on a large roll. A production printer typically includes a localized print controller that controls the overall operation of the printing system, and a print engine that includes one or more printhead assemblies, where each assembly includes a printhead controller and a printhead (or array of printheads). Each printhead contains many nozzles (e.g., inkjet nozzles) for the ejection of ink or any colorant suitable for printing on a medium.

### SUMMARY

In one embodiment, a system is disclosed. The system includes a printing system comprising at least one physical memory device to store compensation logic and one or more processors coupled with the at least one physical memory device to execute the compensation logic to receive sheetside compensation instructions from an external device; wherein the sheetside compensation instructions specify compensation resources, determine a first of a plurality of sheetside images for application of the compensation resources, determine a sheet identifier (ID) corresponding to the first sheetside image, process the first sheetside image by applying the compensation resources to the first sheetside image and transmit the sheet ID to the external device.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIGS. 2A&2B are block diagrams illustrating embodiment of a print controller;

FIG. 3 illustrates one embodiment of sheetside compensation logic;

FIG. 4 is a flow diagram illustrating one embodiment of a process 400 for dynamically adjusting print compensation parameters;

FIG. 5 illustrates one embodiment of a print verification system;

FIG. 6 is a flow diagram illustrating one embodiment of a process performed by a print verification system;

FIG. 7 illustrates one embodiment of a computer system.

### DETAILED DESCRIPTION

A mechanism to dynamically adjust print compensation parameters is described. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

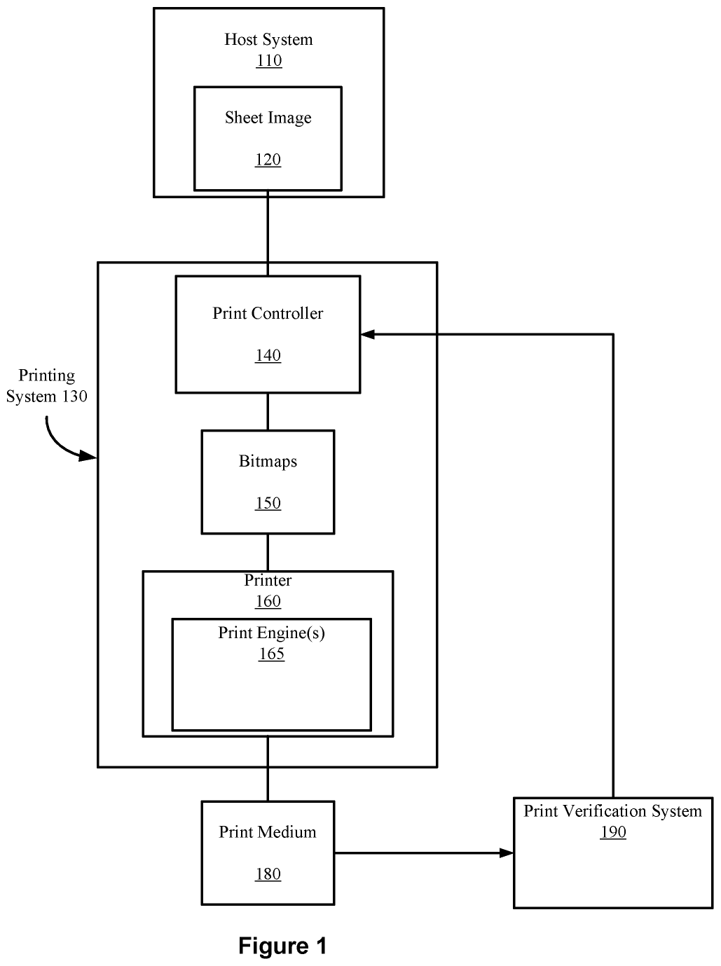

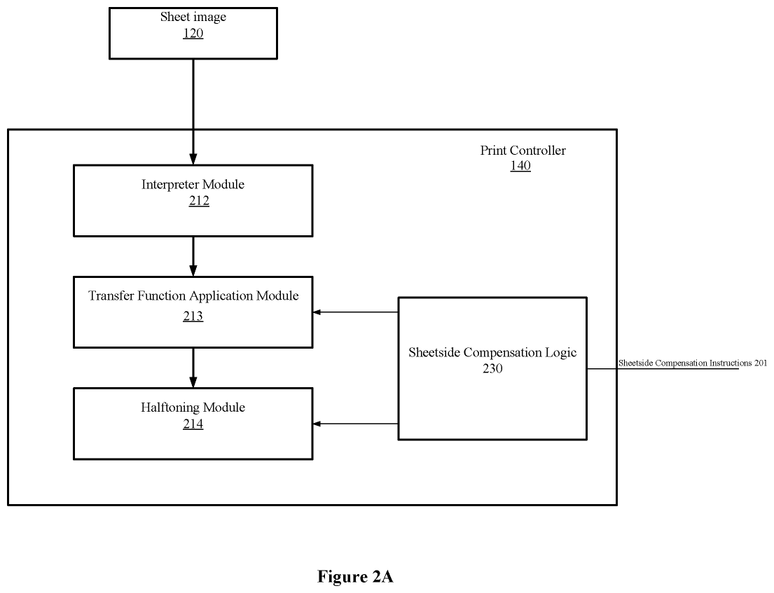

FIG. 1 is a block diagram illustrating one embodiment of a printing system 130. A host system 110 is in communication with the printing system 130 to print a sheet image 120 onto a print medium 180 (e.g., paper) via a printer 160. The resulting print medium 180 may be printed in color and/or in any of a number of gray shades, including black and white (e.g., Cyan, Magenta, Yellow, and black, (CMYK)). The host system 110 may include any computing device, such as a personal computer, a server, cloud infrastructure, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image 120 to generate a bitmap 150 (e.g., a halftoned bitmap) for printing to the print medium 180 via the printer 160.

The printing system 130 may be a high-speed printer operable to print relatively high volumes (e.g., greater than 100 pages per minute). The print medium 180 may be continuous form paper, cut sheet paper, and/or any other tangible medium suitable for printing. The printing system 130, in one generalized form, includes the printer 160 having one or more print engines 165 to present the bitmap 150 onto the print medium 180 via marking material (e.g., toner, ink, coatings, etc.) based on the sheet image 120.

Print controller 140 and printer 160 may be both implemented in the same printing system 130 or implemented separately and coupled together. In another embodiment, print controller 140 may be implemented in host system 110 and coupled to printer 160. Print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities.

In one embodiment, print verification system 190 is implemented to detect print quality defects on the printed substrate. Print quality defects may be defects from faulty print marking on the substrate and/or physical defects in the substrate (e.g., impurities, spots, stains, flutter, cockle, wrinkles, z-direction defects) and/or printer response drifts (e.g., measured optical density that deviates from a target). In one embodiment, print verification system 190 may report results of any detected print quality defects to print controller 140 for further processing. Print verification system 190 may be a stand-alone component or may be integrated into printing system 130.

Although print verification system 190 enables the real time detection of print quality defects on printed sheets and generation of sheetside compensation instructions, conventional printing systems 130 require printing operations to be stopped to upload sheetside compensation instructions to print engine 165 to correct these problems. According to one embodiment, mechanisms are provided at print controller 140 and print verification system 190 to facilitate the dynamic generation and application of sheetside compensation instructions including compensation resources (e.g., jet out compensation, uniformity compensation, tone curve response) to adjust for print quality defects without having to stop printing operations. A technical benefit resulting from dynamic generation and application of sheetside compensation without stopping printing operations is improved system throughput efficiency.

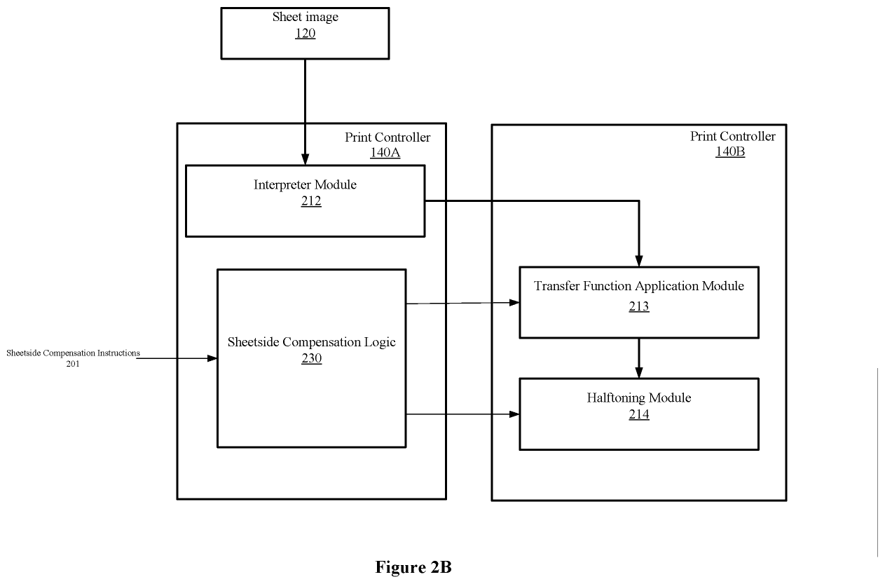

FIG. 2A illustrate one embodiment of a print controller 140. The print controller 140, in its generalized form, includes an interpreter module 212, a transfer function application module 213, a halftoning module 214, and sheetside compensation logic 230. These separate components may represent hardware used to implement the print controller 140. Alternatively, or additionally, the separate components may represent logical blocks implemented by executing software instructions in a processor of the printer controller 140.

FIG. 2B illustrates an alternative embodiment having print controllers 140A&140B. In this embodiment, print controller 140A includes interpreter module 212 and sheetside compensation logic 230, and print controller 140B includes transfer function application module 213 and halftoning module 214. Print controllers 140A and 140B may be implemented in the same printing system 130 (as shown) or may be implemented separately.

Interpreter module 212 is operable to interpret, render, rasterize, or otherwise convert images (e.g., raw sheetside images such as sheet image 120) of a print job into sheetside bitmaps (e.g., contone images or continuous tone images). The sheetside bitmaps generated by the interpreter module 212 for each primary color are each a 2-dimensional array of pels representing an image of the print job (e.g., a Continuous Tone Image (CTI)), also referred to as sheetside bitmaps or sheetside images. The 2-dimensional pel arrays are considered “full” sheetside bitmaps because the bitmaps include the entire set of pels for the image. Interpreter module 212 is operable to interpret or render multiple raw sheetsides concurrently so that the rate of rendering substantially matches the rate of imaging of production print engines. In one embodiment, transfer functions may be implemented by print controller 140 and applied directly to image data as a part of the image processing prior to printing. In that case, the CTI is transformed by the transfer functions prior to halftoning.

Halftoning module 214 is operable to represent the sheetside bitmaps (e.g., sheetside images) as halftone patterns of ink. For example, halftoning module 214 may convert the pels (also known as pixels) to halftone patterns of CMYK ink for application to the paper. A halftone design may comprise a pre-defined mapping of input pel gray levels to output drop sizes based on pel location.

In one embodiment, the halftone design may include a finite set of transition thresholds between a finite collection of successively larger instructed drop sizes, beginning with zero and ending with a maximum drop size (e.g., none, small, medium and or large). The halftone design may be implemented as threshold arrays (e.g., halftone threshold arrays) such as single bit threshold arrays or multibit threshold arrays). In another embodiment, the halftone design may include a three-dimensional look-up table with all included gray level values.

In a further embodiment, halftoning module 214 performs the multi-bit halftoning using the halftone design comprising a set of threshold values for each pel in the sheetside bitmap, where there is one threshold for each non-zero ink drop size. The pel is halftoned with the drop size corresponding to threshold values for that pel. The set of thresholds for a collection of pels is referred to as a multi-bit threshold array (MTA).

Multi-bit halftoning is a halftone screening operation in which the final result is a selection of a specific drop size available from an entire set of drop sizes that the print engine is capable of employing for printing. Drop size selection based on the contone value of a single pel is referred to as “Point Operation” halftoning. The drop size selection is based on the contone pel values in the sheetside bitmap.

This contrasts with “Neighborhood Operation” halftoning, where multiple pels in the vicinity of the pel being printed are used to determine the drop size. Examples of neighborhood operation halftoning include the well-known error diffusion method.

Multi-bit halftoning is an extension of binary halftoning, where binary halftoning may use a single threshold array combined with a logical operation to decide if a drop is printed based on the contone level for a pel. Binary halftoning uses one non-zero drop size plus a zero drop size (i.e., a drop size of none where no ink is ejected). Multi-bit halftoning extends the binary threshold array concept to more than one non-zero drop size.

Multi-bit halftoning may use multiple threshold arrays (i.e., multi-bit threshold arrays), one threshold array for each non-zero drop size. The point operation logic is also extended to a set of greater than, less than, or equal to operations to determine the drop size by comparing the threshold and image contone data for each pel. Multi-bit defines a power of two set of drop sizes (e.g., two-bit halftone designs have four total drops, including a zero drop size). While power of two may be employed to define the number of drops, systems not following this such as a three total drop system may be used and are still considered multi-bit.

A transfer function application module 213 is implemented to apply compensation transfer functions to print image data (e.g., CTI data, sheetside images) received from interpreter module 212 prior to performing halftoning at halftoning module 214. In one embodiment, a transfer function comprises a mapping of an input digital count (or tint) to an output digital count for a system, where digital count is the gray level or color value representing the pels in a sheetside bitmap (FIG. 1).

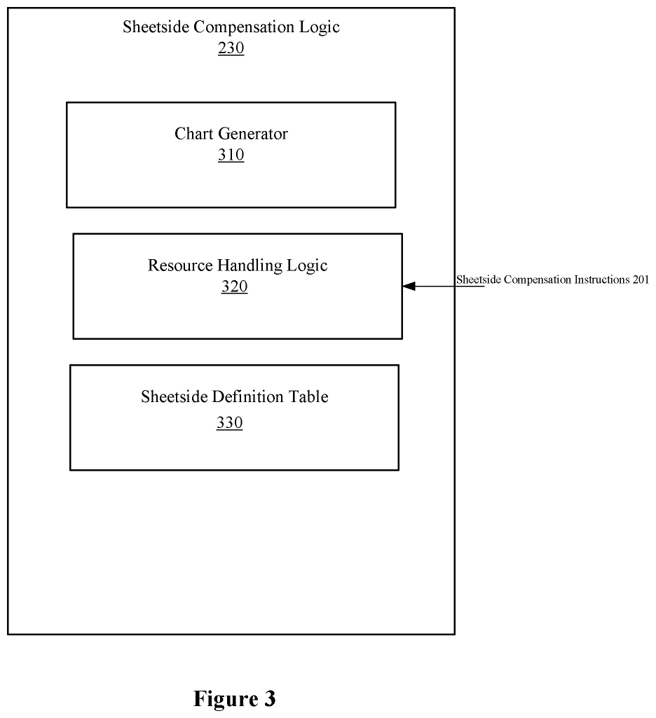

Sheetside compensation logic 230 receives sheetside compensation instructions 201 that include compensation resources from print verification system 190. Additionally, sheetside compensation logic 230 facilitates application of the compensation resources to sheetside images (e.g., sheetside bitmaps) to compensate for defects detected at print verification system 190 while print production continues operation at printing system 130. FIG. 3 illustrates one embodiment of sheetside compensation logic 230. According to one embodiment, sheetside compensation logic 230 receives sheetside compensation instructions 201 from an external device, determines a first of a plurality of sheetside images for application of the compensation resources specified in the sheetside compensation instructions 201, determines a sheet identifier (ID) uniquely corresponding to a first sheetside image, processes the first sheetside image by applying the compensation resources to the first sheetside image and transmits the sheet ID to the external device. In a further embodiment, the external device comprises a print verification and compensation system (e.g., print verification system 190).

As shown in FIG. 3, sheetside compensation logic 230 includes a chart generator 310 that is implemented to generate diagnostic print pattern instructions that are included within print job data to be printed. In one embodiment, each diagnostic print pattern includes color charts having colors associated with each ink color printed at printing system 130. In a further embodiment, print verification system 190 captures images of the diagnostic print patterns and uses the captured images to detect printing defects (e.g., one or more defective pel forming elements, changes in a non-uniformity pattern or absolute tonal response, etc.). The printed sheets with diagnostic print patterns may be discarded (e.g., during post-processing) after the corresponding captured images are processed at print verification system 190.

Sheetside compensation logic 230 also includes resource handling logic 320. In one embodiment, resource handling logic 320 receives sheetside compensation instructions 201 from print verification system 190. As mentioned above, sheetside compensation instructions 201 include compensation resources. In a further embodiment, the compensation resources comprise one or more updated compensation (or correction) parameters (e.g., halftone designs and/or transfer functions) from compensation parameters currently being applied (e.g., previous compensation parameters) to sheetside images.

Upon receiving the sheetside compensation instructions 201, resource handling logic 320 determines a first sheetside image (e.g., after a last sheetside image using the previous compensation parameters) to apply the updated compensation parameters. Sheetside compensation instructions 201 then facilitate processing the first sheetside image by providing the updated compensation parameters (e.g., via an updated sheetside definition table 330) to transfer function application module 213 and halftone module 214 for application to the first sheetside image to be processed.

According to one embodiment, successive sheetside images that follow the first sheetside image (e.g., next sheet or subsequent sheets) also implement the application of updated compensation parameters. However, sheetside images in process prior to the first sheetside image are processed using the previous compensation parameters. Thus, the previous compensation resources remain available while the previous sheetside images are processed. Keeping the compensation resources available results in the technical benefit of ensuring that the next and logical successive sheetside images all use the updated compensation resources to facilitate printing of the sheetsides with the applied updated compensation starting at a defined sheetside and continuing in logical sheetside order without reversion.

In one embodiment, sheetside compensation logic 230 stores the updated compensation parameters in sheetside definition table 330, which includes a listing of each sheetside image to be processed. In one embodiment, the listing for each of a plurality of sheetside images to be processed comprise an associated sheet identifier (sheet ID) that is used to identify the sheetside image. Additionally, each sheetside image listing in table 330 includes the associated compensation parameters (e.g., directly stored or by reference) that are to be applied to the sheetside image. Accordingly, sheetside compensation logic 230 determines the compensation parameters to be applied for each sheet ID (e.g., the first and all subsequent sheetside images) based on the sheet ID entry located in sheetside definition table 330. In a further embodiment, the sheet ID associated with the first sheetside image is transmitted to print verification system 190 prior to the processed first sheetside image (e.g., corresponding bitmaps 150) being transmitted to printer 160 for printing.

In yet another embodiment, the sheet ID associated with the first sheetside image is transmitted prior to processing the first sheetside image. A technical benefit resulting from transmitting the sheet ID associated with the first sheetside image prior to transmitting processed first sheetside image and/or prior to processing the first sheetside image includes allowing the print verification system 190 time to process the transmitted sheet ID before the printed first side image reaches the print verification system 190.

According to one embodiment, the compensation parameters are retrieved based on sheetside definition table 330 (e.g., either directly from sheetside definition table 330 or by a reference in sheetside definition table to a storage location) by transfer function application module 213 and/or halftone module 214 and applied to the corresponding sheetside images. Subsequently, the sheetside images processed using the updated compensation parameters are transmitted for printing to printer 160.

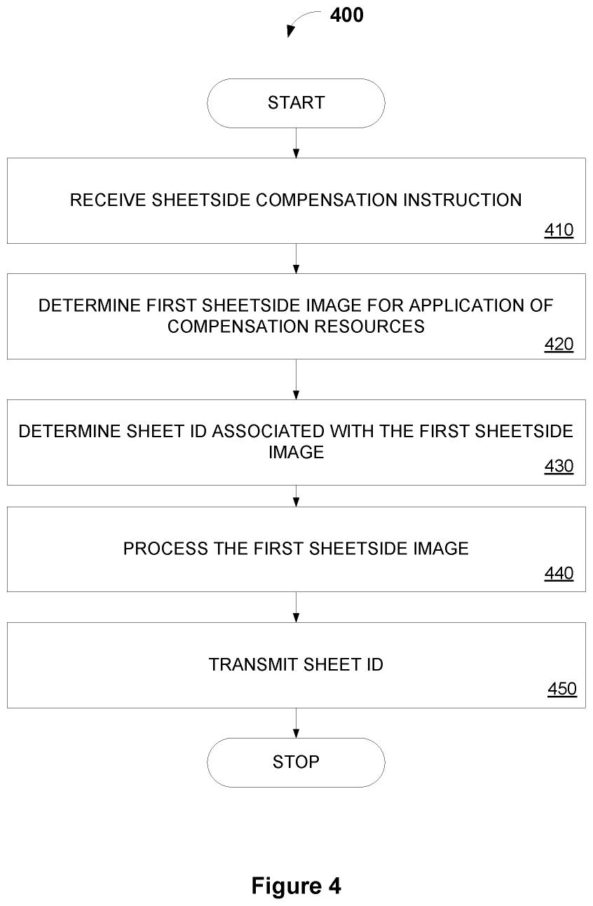

FIG. 4 is a flow diagram illustrating one embodiment of a process 400 for dynamically adjusting print compensation parameters. Process 400 may be performed by processing logic that may include hardware (e.g., circuitry, dedicated logic, programmable logic, microcode, etc.), software such as instructions run on a processing device, or a combination thereof. In one embodiment, process 400 is performed by print controller 140.

At processing block 410, sheetside compensation instructions 201 is received from an external device (e.g., print verification system 190). At processing block 420, a first sheetside image for application of compensation resources included in the sheetside compensation instructions 201 is determined. At processing block 430, the sheet ID associated with the first sheetside image (e.g., the first sheet ID) is determined (e.g., print controller 140 selects the first sheet ID). At processing block 440, the first sheetside image is processed by applying the corresponding sheetside compensation instruction to the first sheetside image to generate bitmaps 150. At processing block 450, the first sheet ID is transmitted to the external device. Bitmaps 150 are transmitted to printer 160 for printing with the printed sheets output in logical sheetside order.

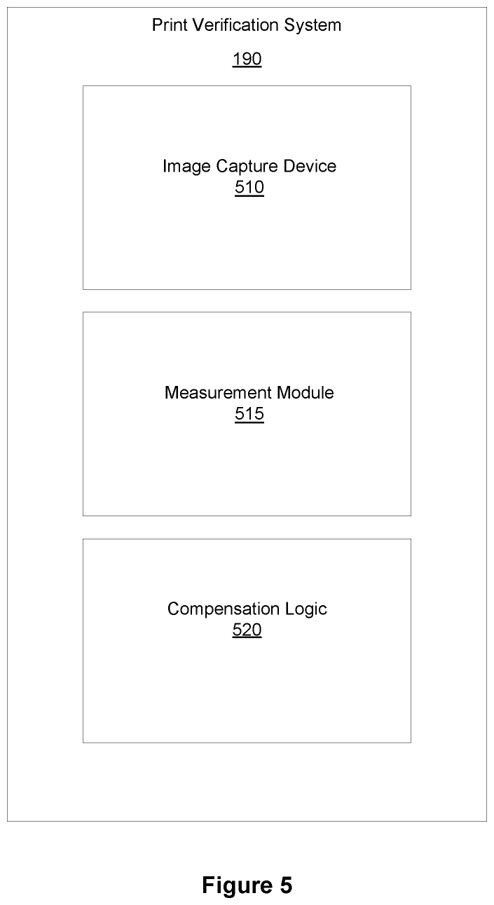

According to one embodiment, print verification system 190 receives the sheet ID and generates compensation parameters based on the sheet ID for the captured first sheet print image and captured subsequent sheet print images. The sheet ID indicates the compensation resources that were applied to the first sheet print image and subsequent sheet print images. Subsequent sheet print images are printed after the printing of the first sheet print image. FIG. 5 illustrates one embodiment of a print verification system 190. As shown in FIG. 5, print verification system 190 includes an image capture device 510 and compensation logic 520. In one embodiment, image capture device 510 includes one or more cameras. However, in other embodiments, image capture device 510 may include different types of image capture devices.

Print verification system 190 also includes a measurement module 515 that generates measurement data (e.g., reflectance, intensity, etc.) for captured images containing diagnostic print patterns for each color band. Compensation logic 520 performs a compensation process based on measurement data received from measurement module 515 and the sheet ID. Compensation logic 520 identifies current compensation resources stored in memory that were used to print the sheet based on the sheet ID. In one embodiment, compensation logic 520 uses the measurement data to detect printing defects and generate compensation resources to compensate for the print quality defects. In such an embodiment, the compensation resources comprise at least one of compensated halftones and compensated transfer functions with a resulting technical benefit of providing any combination of compensation resources.

According to one embodiment, compensation logic 520 generates updated compensated halftones by performing the compensation process on previously generated compensated halftones (e.g., current compensated halftones) applied to sheetside images at print controller 140. Subsequently, the updated compensated halftones and/or updated transfer functions are included as compensation resources within sheetside compensation instructions 201 that is transmitted to sheetside compensation logic 230.

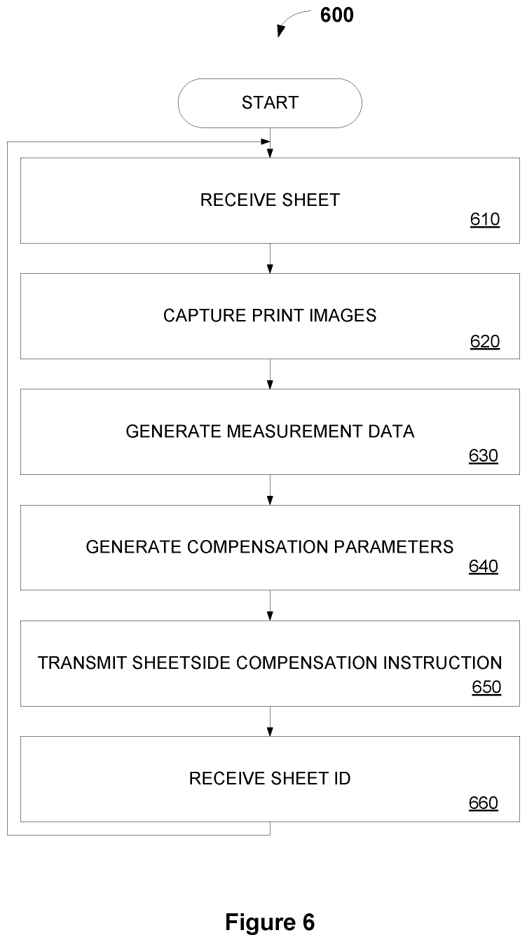

FIG. 6 is a flow diagram illustrating one embodiment of a process 600 for a print verification and compensation. Process 600 may be performed by processing logic that may include hardware (e.g., circuitry, dedicated logic, programmable logic, microcode, etc.), software such as instructions run on a processing device, or a combination thereof. In one embodiment, process 600 is performed by print verification system 190.

At processing block 610, a sheet including printed data is received. At processing block 620 images of the printed data are captured. At processing block 630, measurement data is generated based on the captured image data. As discussed above, the measurement data may be generated using color charts within diagnostic print patterns. At processing block 640, the compensation parameters are generated based on the measurement data and the compensation resources associated with the sheet ID. At processing block 650, sheetside compensation instructions 201 including the compensation parameters is transmitted to sheetside compensation logic 230. Sometime later, a sheet ID associated with the first sheetside image to be processed using the compensation parameters is received, processing block 660. Subsequently, control is returned to processing block 610, where a subsequent sheet is received including data printed using the compensation parameters.

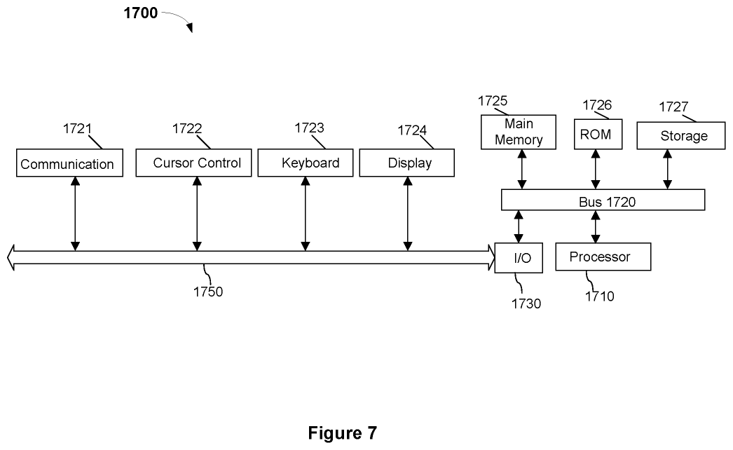

FIG. 7 illustrates a computer system 1700 on which printing system 130 and/or print controller 140 may be implemented. Computer system 1700 includes a system bus 1720 for communicating information, and a processor 1710 coupled to bus 1720 for processing information.

Computer system 1700 further comprises a random-access memory (RAM) or other dynamic storage device 1725 (referred to herein as main memory), coupled to bus 1720 for storing information and instructions to be executed by processor 1710. Main memory 1725 also may be used for storing temporary variables or other intermediate information during execution of instructions by processor 1710. Computer system 1700 also may include a read only memory (ROM) and or other static storage device 1726 coupled to bus 1720 for storing static information and instructions used by processor 1710.

A data storage device 1727 such as a magnetic disk or optical disc and its corresponding drive may also be coupled to computer system 1700 for storing information and instructions. Computer system 1700 can also be coupled to a second I/O bus 1750 via an I/O interface 1730. A plurality of I/O devices may be coupled to I/O bus 1750, including a display device 1724, an input device (e.g., an alphanumeric input device 1723 and or a cursor control device 1722). The communication device 1721 is for accessing other computers (servers or clients). The communication device 1721 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a printing system comprising at least one physical memory device to store compensation logic and one or more processors coupled with the at least one physical memory device to execute the compensation logic to receive sheetside compensation instructions from an external device; wherein the sheetside compensation instructions specify compensation resources, determine a first of a plurality of sheetside images for application of the compensation resources, determine a sheet identifier (ID) corresponding to the first sheetside image, process the first sheetside image by applying the compensation resources to the first sheetside image and transmit the sheet ID to the external device.

Example 2 includes the subject matter of Example 1, wherein the processing further comprises halftoning the sheetside image using a halftone design included in the compensation resources.

Example 3 includes the subject matter of Examples 1 and 2, wherein processing the first sheetside image comprises applying one or more transfer functions to the sheetside image, wherein the transfer functions are included in the compensation resources.

Example 4 includes the subject matter of Examples 1-3, wherein the sheet ID is transmitted prior to processing the first sheetside image.

Example 5 includes the subject matter of Examples 1-4, wherein the compensation logic further to transmit the processed first sheetside image.

Example 6 includes the subject matter of Examples 1-5, further comprising the external device, including a print verification and compensation system.

Example 7 includes the subject matter of Examples 1-6, wherein the print verification and compensation system receives the sheet ID and generates updated compensation resources for the captured first sheet print image and captured subsequent sheet print images based on measurement data and the sheet ID.

Example 8 includes the subject matter of Examples 1-7, wherein the print verification and compensation system generate the updated compensation resources based on current compensation resources indicated by the sheet ID.

Example 9 includes the subject matter of Examples 1-8, wherein the compensation resources comprise at least one of compensated halftones and compensated transfer functions.

Example 10 includes the subject matter of Examples 1-9, further comprising a printer to print the processed first sheetside image.

Some embodiments pertain to Example 11 that includes a method comprising receiving sheetside compensation instructions from an external device; wherein the sheetside compensation instructions specify compensation resources, determining a first of a plurality of sheetside images for application of the compensation resources, determining a sheet identifier (ID) corresponding to the first sheetside image, processing the first sheetside image by applying the compensation resources to the first sheetside image and transmitting the sheet ID to the external device.

Example 12 includes the subject matter of Example 11, further comprising halftoning the sheetside image using a halftone design included in the compensation resources.

Example 13 includes the subject matter of Examples 11 and 12, wherein processing the first sheetside image comprises applying one or more transfer functions to the sheetside image, wherein the transfer functions are included in the compensation resources.

Example 14 includes the subject matter of Examples 11-13, wherein the sheet ID is transmitted prior to processing the first sheetside image.

Example 15 includes the subject matter of Examples 11-14, further comprising transmitting the processed first sheetside image.

Some embodiments pertain to Example 16 that includes at least one computer readable medium having instructions stored thereon, which when executed by one or more processors, cause the processors to receive sheetside compensation instructions from an external device; wherein the sheetside compensation instructions specify compensation resources, determine a first of a plurality of sheetside images for application of the compensation resources, determine a sheet identifier (ID) corresponding to the first sheetside image, process the first sheetside image by applying the compensation resources to the first sheetside image and transmit the sheet ID to the external device.

Example 17 includes the subject matter of Example 16, having instructions stored thereon, which when executed by one or more processors, further cause the processors to halftone the sheetside image using a halftone design included in the compensation resources.

Example 18 includes the subject matter of Examples 16 and 17, wherein processing the first sheetside image comprises applying one or more transfer functions to the sheetside image, wherein the transfer functions are included in the compensation resources.

Example 19 includes the subject matter of Examples 16-18, wherein the sheet ID is transmitted prior to processing the first sheetside image.

Example 20 includes the subject matter of Examples 16-19, having instructions stored thereon, which when executed by one or more processors, further cause the processors to transmit the processed first sheetside image.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printing system comprising:
at least one physical memory device to store compensation logic; and
one or more processors coupled with the at least one physical memory device to execute the compensation logic to:
receive sheetside compensation instructions from an external device; wherein the sheetside compensation instructions specify compensation resources;
determine a first of a plurality of sheetside images for application of the compensation resources;
determine a sheet identifier (ID) corresponding to the first sheetside image;
process the first sheetside image by applying the compensation resources to the first sheetside image; and
transmit the sheet ID to the external device.

2. The system of claim 1, wherein the processing further comprises halftoning the sheetside image using a halftone design included in the compensation resources.

3. The system of claim 1, wherein processing the first sheetside image comprises applying one or more transfer functions to the sheetside image, wherein the transfer functions are included in the compensation resources.

4. The system of claim 1, wherein the sheet ID is transmitted prior to processing the first sheetside image.

5. The system of claim 1, wherein the compensation logic further to transmit the processed first sheetside image.

6. The system of claim 1, further comprising the external device, including:
a print verification; and
compensation system.

7. The system of claim 6, wherein the print verification and compensation system receives the sheet ID and generates updated compensation resources for the captured first sheet print image and captured subsequent sheet print images based on measurement data and the sheet ID.

8. The system of claim 6, wherein the print verification and compensation system generates the updated compensation resources based on current compensation resources indicated by the sheet ID.

9. The system of claim 1, wherein the compensation resources comprise at least one of compensated halftones and compensated transfer functions.

10. The system of claim 6, further comprising a printer to print the processed first sheetside image.

11. A method comprising:
receiving sheetside compensation instructions from an external device; wherein the sheetside compensation instructions specify compensation resources;
determining a first of a plurality of sheetside images for application of the compensation resources;
determining a sheet identifier (ID) corresponding to the first sheetside image;
processing the first sheetside image by applying the compensation resources to the first sheetside image; and
transmitting the sheet ID to the external device.

12. The method of claim 11, further comprising halftoning the sheetside image using a halftone design included in the compensation resources.

13. The method of claim 11, wherein processing the first sheetside image comprises applying one or more transfer functions to the sheetside image, wherein the transfer functions are included in the compensation resources.

14. The method of claim 11, wherein the sheet ID is transmitted prior to processing the first sheetside image.

15. The method of claim 11, further comprising transmitting the processed first sheetside image.

16. At least one computer readable medium having instructions stored thereon, which when executed by one or more processors, cause the processors to:
receive sheetside compensation instructions from an external device; wherein the sheetside compensation instructions specify compensation resources;
determine a first of a plurality of sheetside images for application of the compensation resources;
determine a sheet identifier (ID) corresponding to the first sheetside image;
process the first sheetside image by applying the compensation resources to the first sheetside image; and
transmit the sheet ID to the external device.

17. The computer readable medium of claim 16, having instructions stored thereon, which when executed by one or more processors, further cause the processors to halftone the sheetside image using a halftone design included in the compensation resources.

18. The computer readable medium of claim 16, wherein processing the first sheetside image comprises applying one or more transfer functions to the sheetside image, wherein the transfer functions are included in the compensation resources.

19. The computer readable medium of claim 16, wherein the sheet ID is transmitted prior to processing the first sheetside image.

20. The computer readable medium of claim 16, having instructions stored thereon, which when executed by one or more processors, further cause the processors to transmit the processed first sheetside image.
